(19) United States
(12) Patent Application Publication
(10) Pub. No.: US 2018/0011890 A1
(43) Pub. Date: Jan. 11, 2018

(54) MANAGEMENT SYSTEM, AND MANAGEMENT METHOD

(71) Applicant: Hitachi, Ltd., Tokyo (JP)

(72) Inventors: Koichiro YAZAWA, Tokyo (JP); Shinichi NAKAZAKI, Tokyo (JP); Kiyohiko NARAZAKI, Tokyo (JP); Katsutaka INOUE, Tokyo (JP)

(21) Appl. No.: 15/545,438

(22) PCT Filed: Jun. 30, 2015
(86) PCT No.: PCT/JP2015/068817

§ 371 Date: Jul. 21, 2017

(51) Int. Cl. G06F 17/30; G06F 9/44; G06F 9/445

(52) U.S. Cl. CPC G06F 17/30353; G06F 8/65; G06F 8/71

(57) ABSTRACT

In the present invention, a management system has a storage device and a processor. The storage device holds an information processing program for controlling information pertaining to a storage system by utilizing a database. The processor executes an update program that updates the information processing program and the database utilized by the information processing program. The update program calculates an estimated update time needed to update the information processing program and the database on the basis of the size of at least a portion of the database utilized by the information processing program before being updated and the structure of the database utilized by the information processing program after being updated, and outputs the estimated update time thus calculated.

### TECHNICAL FIELD

The present invention generally relates to technology for managing a storage system.

### BACKGROUND ART

Technology is known that, when updating a program installed in a computer, calculates a time it is estimated will be needed to update the update program based on the file size of the update program and displays the calculated time (PTL 1).

### CITATION LIST

### Patent Literature

[PTL 1] Japanese Patent Laid-Open No. 2006-227871

### SUMMARY OF INVENTION

### Technical Problem

When a time estimated to be needed to update a program installed in a server constituting a storage system is calculated based on the file size of the update program, in some cases the estimated time deviates significantly from the time that is actually taken for updating. For example, in a case where a program that is an update target utilizes a database (DB) and it is necessary to also update the structure and values of the DB in addition to the program that is the update target, the update time will change significantly depending on the size and the like of the DB.

Therefore, an object of the present invention is to more accurately estimate an update time of a program that is installed in a server constituting a storage system.

### Solution to Problem

A management system according to one embodiment of the present invention is a system configured to manage a storage system, and includes a storage device and a processor. The storage device is configured to hold an information processing program configured to control information pertaining to the storage system by utilizing a database. The processor is configured to execute an update program configured to update the information processing program and the database utilized by the information processing program. The update program calculates an estimated update time that is an estimated time that will be needed to update the information processing program and the database based on a size of at least one portion of the database utilized by the information processing program before being updated and a structure of the database utilized by the information processing program after being updated, and outputs the estimated update time that is calculated.

### Advantageous Effects of Invention

According to the present invention, an update time of a program that is installed in a server constituting a storage system can be estimated more accurately.

### BRIEF DESCRIPTION OF DRAWINGS

FIG. 1 illustrates a configuration example of a storage system according to the present embodiment.

FIG. 2 illustrates an example of an update selection Graphical User Interface (GUI).

FIG. 3 illustrates an example of an update time point GUI.

FIG. 4 illustrates an example of a warning dialog.

FIG. 5 illustrates an example of an update progress GUI.

FIG. 6 illustrates a configuration example of management DBs of respective versions.

FIG. 7 illustrates a configuration example of monitor DBs of respective versions.

FIG. 8 illustrates an example of a method for calculating a performance ratio.

FIG. 9 illustrates an example of a method for calculating an estimated update time.

FIG. 10 illustrates an example of a flowchart of update reservation processing.

FIG. 11 illustrates an example of a flowchart of update execution processing.

### DESCRIPTION OF EMBODIMENTS

An embodiment will be described below. In the following description, although information is described using the expressions “aaa database”, “aaa table” or “aaa list”, information may be expressed using any kind of data structure. That is, to show that the information is not dependent on the data structure, “aaa database”, “aaa table” or “aaa list” can be referred to as “aaa information”.

In the following description, there may be instances when processing is described using a “program” as the subject, but since the prescribed processing is performed in accordance with a program being executed by a processor (for example, a CPU (Central Processing Unit)) while using at least one of a storage resource (for example, a memory) and a communication interface device as needed, the processor or an apparatus having the processor may also be taken as the subject. One part or all of processing that a processor performs may be performed by a hardware circuit. A computer program may be installed from a program source. The program source may be a program distribution computer or a storage medium (for example, a portable storage medium).

In the following description, a collection of one or more computers configured to manage at least one apparatus included in a computer system may be referred to as a “management system”. In a case where a management computer displays information for display, the management computer may serve as the management system. In addition, a combination of a management computer and a display computer may serve as the management system. Further, in order to enhance the speed and the reliability of management processing, a plurality of computers may be used to realize processing that is identical or similar to that performed by the management computer, and in this case the plurality of computers (which may include a display computer in the case where a display computer is used for display) may serve as the management system. In the present embodiment, a management computer serves as the management system. Further, the phrase “the management computer displays information” may indicate that information is displayed on a display device possessed by the management computer, or may indicate that information for display is transmitted to a display computer (for example, a client) that is coupled to the management computer (for example, a server). In the latter case, the display computer displays information represented by the information for display on a display device possessed by the display computer.

In the following description, when describing elements of a same type while distinguishing the elements from one another, reference symbols such as “aaa 301A” and “aaa 301B” may be used. However, when describing elements of a same type without distinguishing the elements from one another, only a shared number among the reference symbols such as “aaa 301” may be used.

### Embodiment 1

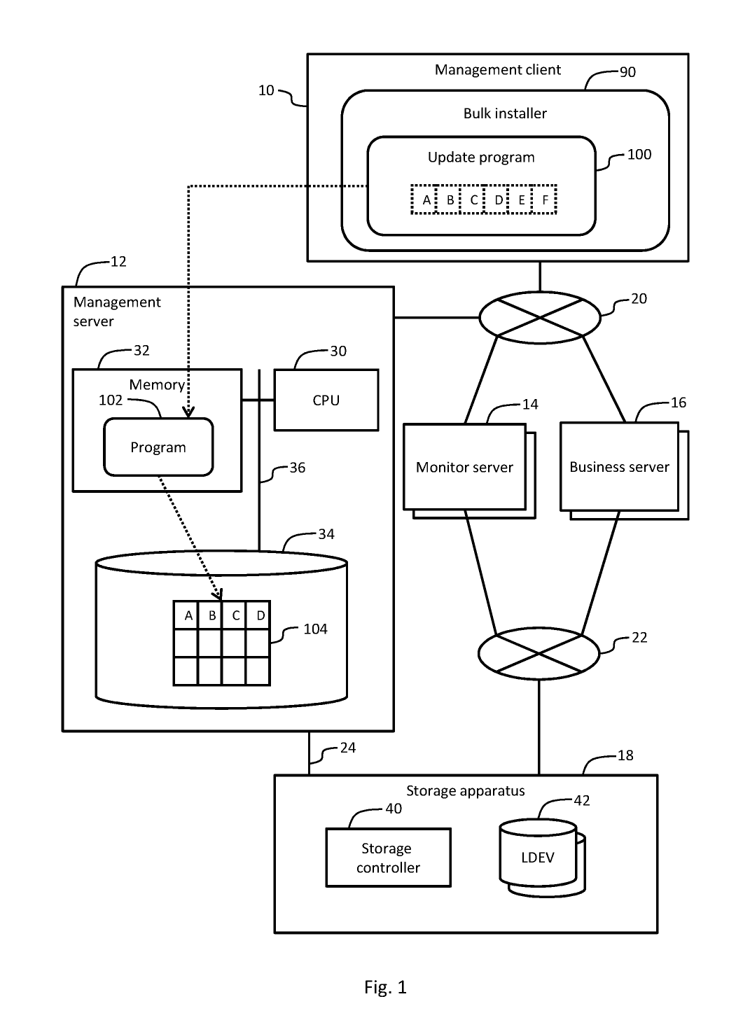

FIG. 1 illustrates a configuration example of a storage system and a management system according to the present embodiment.

The storage system has a storage apparatus 18 and a business server 16. The management system is configured to manage the storage system. The management system has a management server 12 and at least one monitor server 14. The management system may also have a management client 10. Note that this configuration of the storage system and management system is merely one example, and the management system may include some constituent elements of the storage system, and the storage system may include some constituent elements of the management system.

The management server 12, the management client 10, the monitor server 14 and the business server 16 are coupled so as to enable two-way communication through a network 20. The network 20 is, for example, a Local Area network (LAN).

The monitor server 14, the business server 16 and the storage apparatus 18 are coupled so as to enable two-way communication through a network 22. The network 22 is, for example, a Fibre Channel-Storage Area Network (FC-SAN).

The management server 12 and the storage apparatus 18 are coupled so as to enable two-way communication through a network 24 (or a predetermined cable). The network 24 is, for example, a LAN.

The storage apparatus 18 includes a plurality of non-volatile storage devices (not shown in the drawing). The storage devices are, for example, a Hard Disk Drive (HDD) or a Solid State Drive (SSD). The storage apparatus 18 may constitute a Redundant Arrays of Inexpensive Disks (RAID) group formed from the plurality of storage devices. The storage apparatus 18 may constitute a Logical Device (LDEV) 42 formed from the RAID group. An LDEV may also be referred to as “logical volume”. The storage apparatus 18 may provide the constituted LDEV 42 to the business server 16. These functions may be realized by a storage controller 40 possessed by the storage apparatus 18 executing a predetermined program. The storage controller 40 may have a configuration that includes a Central Processing Unit (CPU) and a memory.

The business server 16 is an apparatus that performs processing relating to business. The business server 16 can issue a read request to the storage apparatus 18, and can read data from the LDEV 42 which is provided to the business server in question. The business server 16 can issue a write request to the storage apparatus 18, and can write data to the LDEV 42 which is provided to the business server 16 in question.

The monitor server 14 is an apparatus that executes a monitor program to monitor the state of at least one of the business server 16, the storage apparatus 18, the management server 12 and the networks 20, 22 and 24. For example, the monitor program periodically collects information regarding the CPU usage rate and the memory free space of the business server 16. The information collected by the monitor program may be referred to as “monitoring information”. The monitor program registers and manages such periodically collected monitoring information in a monitor DB. In a case where the kinds of monitoring information increase as a result of updating the monitor program (for example, in a case where the CPU temperature is newly adopted as a monitoring target), it is necessary to also increase the items (columns) in the monitor DB in accordance therewith. Conversely, if the kinds of monitoring information decrease as a result of updating the monitor program (for example, if the CPU temperature that had been a monitoring target is made a non-monitoring target), it is necessary to also decrease the items (columns) in the monitor DB in accordance therewith.

The management server 12 is an apparatus configured to execute a management program to manage the overall storage system. For example, the management program is configured to manage which LDEV 42 is provided to which business server 16 among a plurality of the business servers 16. The management program may manage a path (referred to as “disk path”) that links the business server 16 and the LDEV 42. The management program may manage which pool the respective LDEVs 42 belong to. The information that is managed by the management program is referred to collectively as “management information”. The management program registers and manages the management information in a management DB. In a case where the kinds of management information increase as a result of updating the management program (for example, in a case where a pool to which LDEVs 42 belong is newly adopted as a management target), it is necessary to also increase the items (columns) in the management DB in accordance therewith. Conversely, if the kinds of management information decrease as a result of updating the management program (for example, if a pool to which LDEVs 42 belong that had been a management target is made a non-management target), it is necessary to also decrease the items (columns) in the management DB in accordance therewith.

The management server 12 may be configured to execute both the management program and the monitor program. In this case, the management server 12 may have the management DB and the monitor DB. The management server 12 may also be configured to execute a plurality of monitor programs. In this case, the management server 12 may have a monitor DB for each monitor program. Further, a server including at least one of the management server 12 and the monitor server 14 may be referred to as an “information processing server”. Furthermore, a program including at least one of the management program and the monitor program may be referred to as an “information processing program”.

The management client 10 is an apparatus for allowing a user to manage the management server 12 and/or the monitor server 14. The management client 10 may be capable of accessing the management server 12 and/or the management server 14 through the network 20. The user may be able to update the management program and/or monitor program of the management server 12 and/or the monitor program of the monitor server 14 through the management client 10. For example, when the user executes a bulk installer 90 at the management client 10, an update program 100 included in the bulk installer 90 may update the management program and/or monitor program of the management server 12 and/or the monitor program of the monitor server 14.

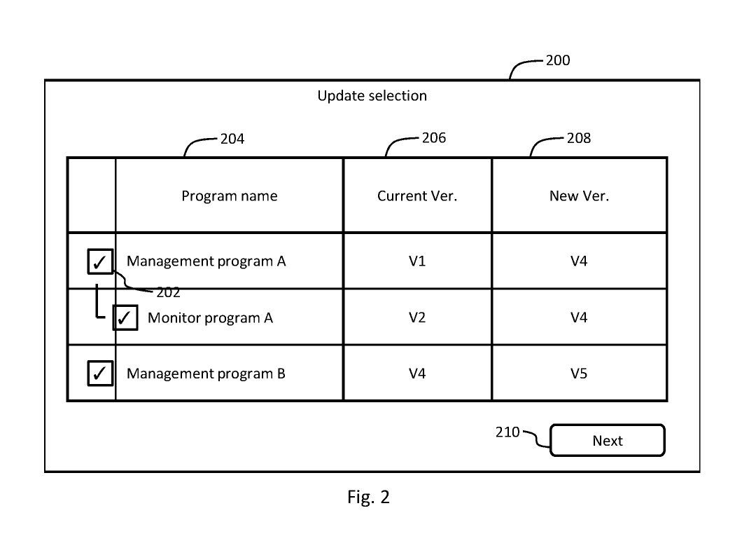

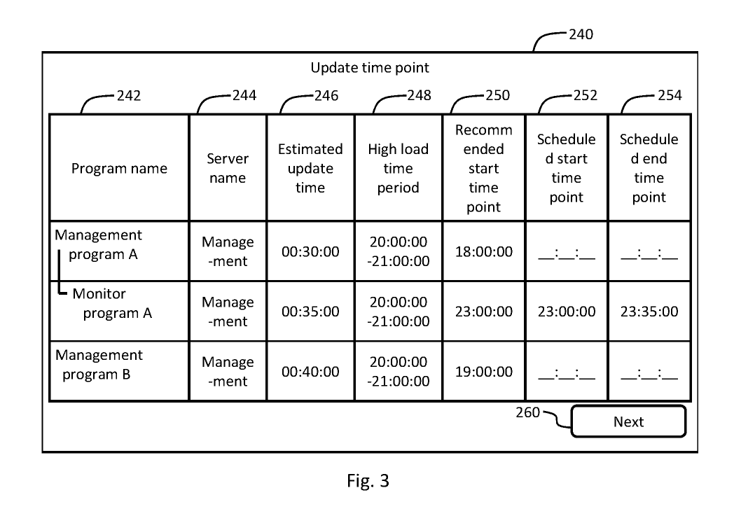

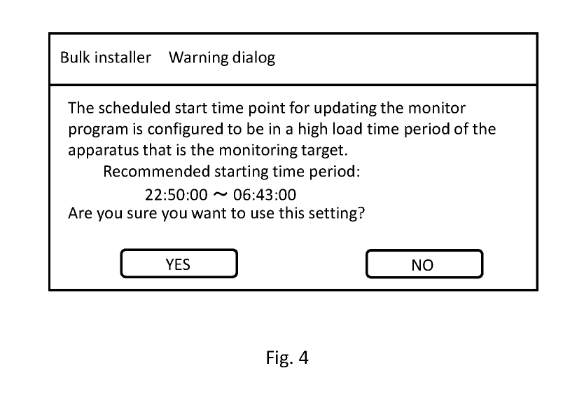

When the bulk installer 90 is executed, an update selection GUI 200 (see FIG. 2), an update time point GUI 240 (see FIG. 3), and/or an update progress GUI 260 (see FIG. 4) may be displayed as appropriate on a display device of the management client 10.

Note that the bulk installer 90 may be directly executed at the management server 12 or the monitor server 14. In this case, the GUIs 200, 240 and 260 may be displayed on a display device of the management server 12 or the monitor server 14. For example, the GUIs 200, 240 and 260 may be displayed as appropriate when the user inserts an optical disk on which the bulk installer 90 is recorded into an optical drive of the management server 12 and executes the bulk installer 90.

Next, an overview of processing in the present embodiment will be described using FIG. 1.

(S10) When the bulk installer 90 is executed, the bulk installer 90 displays the update selection GUI 200.

(S11) The user performs an operation on the update selection GUI 200 to select the update program 100 to be taken as the execution target. In this case, the update program 100 is a program for updating an information processing program 102 of the management server 12.

(S12) The bulk installer 90 displays the update time point GUI 240. The update time point GUI 240 may display a time (referred to as “estimated update time”) that it is estimated will be taken until the update program 100 selected in S11 is executed and update processing is completed. The bulk installer 90 may calculate the estimated update time based on the size of at least one portion of a DB 104 corresponding to the program 102 that is the current version, and an increase or decrease in items (columns) of a DB corresponding to the update program 100 that is a new version. The example in FIG. 1 shows that there is an increase of two items, namely, items E and F, in the DB corresponding to the update program 100 that is the new version, relative to items A to D of the DB 104 corresponding to the program 102 that is the current version.

(S13) The user performs an operation on the update time point GUI 240 to configure a scheduled start time point of the update program 100.

(S14) The bulk installer 90 displays the update progress GUI 260. The update progress GUI 260 may display the scheduled start time point of the update program 100.

(S15) When the scheduled start time point configured in S13 is reached, the bulk installer 90 starts execution of the update program 100. At this time, the update progress GUI 260 may display the progress status of the overall updating together with the progress status of respective update programs 100.

FIG. 2 illustrates an example of the update selection GUI 200.

The update selection GUI 200 is a GUI for selecting execution targets from among a plurality of update programs included in the bulk installer 90.

For example, for each update program included in the bulk installer 90, the update selection GUI 200 displays a check box 202, a program name 204, a current version 206 and a new version 208.

The program name 204 is the name of the update program.

The check box 202 is used for configuring whether or not to make the update program having the program name 204 an execution target. For example, the user sets the state of the check box 202 of an update program to be taken as an execution target to “on”.

The current version 206 is the present version of the program that is to be updated by the update program having the program name 204.

The new version 208 is the version which the program will be after being updated by the update program having the program name 204.

Upon being executed, the bulk installer 90 generates the update selection GUI 200 as shown in FIG. 2, and may display the generated GUI 200 on a predetermined display device. The user can press a “next” button 210 on the GUI 200 to issue an instruction to the management server 12 with respect to the update programs to be taken as execution targets.

FIG. 3 illustrates an example of the update time point GUI 240.

The update time point GUI 240 is a GUI for configuring an execution time point of each update program with respect to the update programs that were selected as execution targets on the update selection GUI 200.

For example, for each update program that is an execution target, the update time point GUI 240 displays a program name 242, a server name 244, an estimated update time 246, a high load time period 248, a recommended start time point 250, a scheduled start time point 252 and a scheduled end time point 254.

The program name 242 is the name of the update program that is an execution target.

The server name 244 is the name of a server at which the update program having the program name 242 is to be executed.

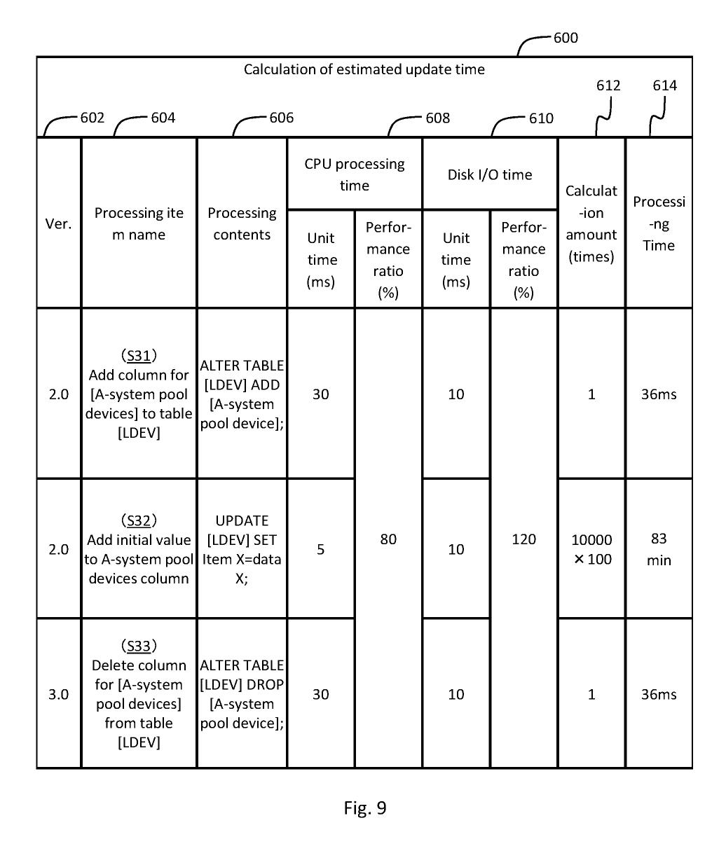

The estimated update time 246 is the time that it is estimated to take until execution of the update program having the program name 242 ends at the server having the server name 244. An example of the method for calculating the estimated update time 246 is described later (see FIG. 9).

The high load time period 248 is a time period in which it is predicted the processing load will be particularly high during one day at the apparatus which the update program having the program name 242 takes as the management target or monitoring target. The high load time period 248 may be calculated based on statistics regarding past processing loads of the apparatus that is the management target or monitoring target. For example, the averages of processing loads for respective time periods during one day may be calculated based on the history of past processing loads, and a time period for which the average of the processing loads is equal to or larger than a predetermined threshold value may be adopted as the high load time period 248.

The recommended start time point 250 is a time point at which it is recommended to start execution of the update program having the program name 242 at the server having the server name 244. The bulk installer 90 may determine the recommended start time point 250 so that a time period from the scheduled start time point 252 until the scheduled end time point 254 does not overlap with at least one portion of the high load time period 258.

The scheduled start time point 252 is a time point at which it is scheduled to start execution of the update program having the program name 242 at the server having the server name 244. The initial value of the scheduled start time point 252 may be any time point among null, the current time point, and the recommended start time point 250. The user may personally input an initial value of the scheduled start time point 252, and may change the initial value to any time point.

The scheduled end time point 254 is a time point at which it is scheduled to end execution of the update program having the program name 242 at the server having the server name 244. The scheduled end time point 254 may be a time point that is obtained by adding the estimated update time 246 to the scheduled start time point 252. If the user changes the scheduled start time point 252, the scheduled end time point 254 may be updated in accordance therewith.

In a case where a time period from the scheduled start time point 252 to the scheduled end time point 254 overlaps with at least one portion of the high load time period 258, the update time point GUI 240 may display a dialog that warns the user to that effect, as illustrated, for example, in FIG. 4.

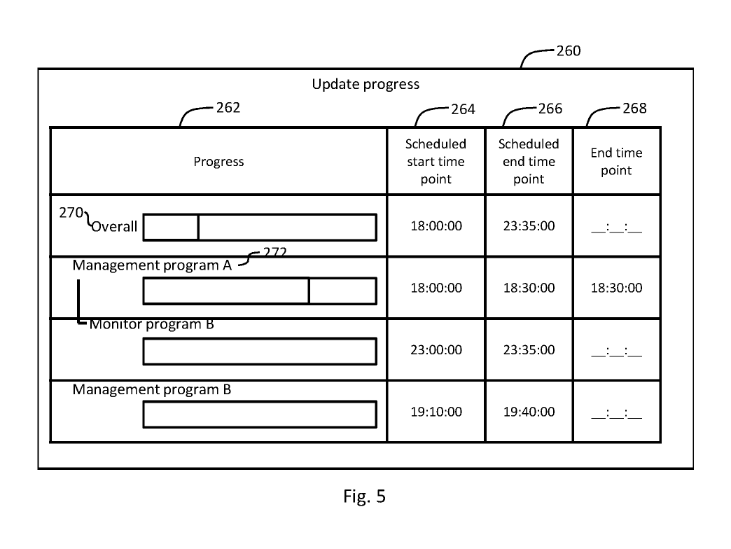

FIG. 5 illustrates an example of the update progress GUI 260.

The update progress GUI 260 is a GUI for displaying the progress of all update programs that were selected as execution targets, the progress of the respective update programs that were selected as execution targets, and the scheduled start time point and the like of the respective update programs.

For example, with respect to overall 270 and respective update programs 272, the update progress GUI 260 displays a progress bar 262, a scheduled start time point 264, a scheduled end time point 266 and an end time point 268.

The progress bar 262 corresponding to overall 270 represents the progress status with respect to all of the updating.

The progress bar 262 corresponding to each update program 272 represents the progress status with respect to the respective update programs.

The scheduled start time point 264 and scheduled end time point 266 corresponding to overall 270 represent the scheduled start time point and the scheduled end time point with respect to all of the updating.

The scheduled start time point 264 and scheduled end time point 266 corresponding to each update program 272 represent the scheduled start time point and the scheduled end time point with respect to the respective update programs.

The end time point 268 is a time point at which updating actually ended.

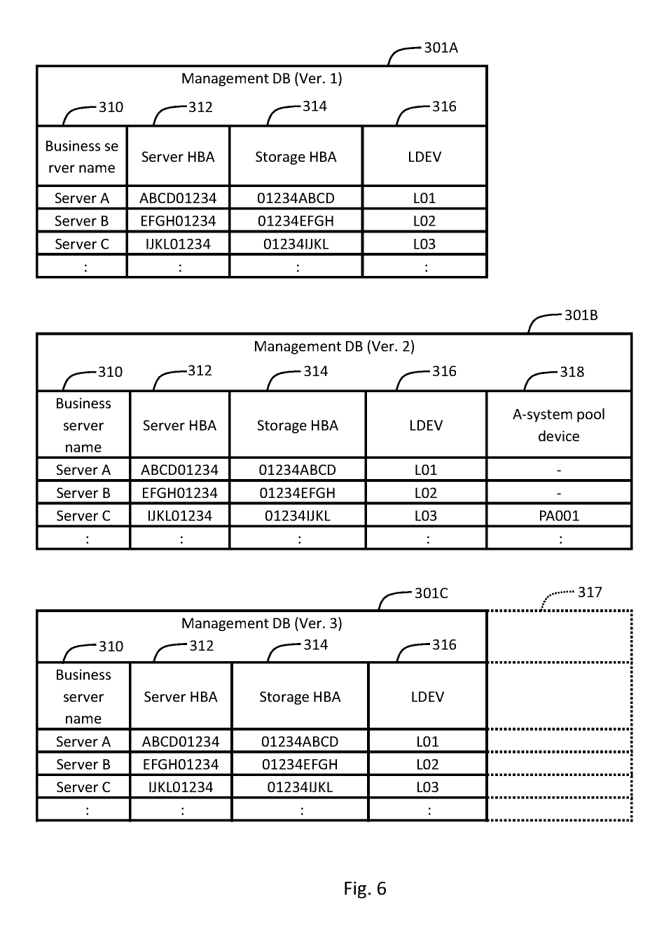

FIG. 6 illustrates configuration examples of the management DB 301 of respective versions. The management DB 301 is utilized from the management program.

In FIG. 6, a management DB 301A shows that, as columns, a management DB of Ver. 1 has a column for a business server name 310, a server Host Bus Adapter (HBA) 312, a storage HBA 314 and an LDEV 316.

The business server name 310 is the name of the business server 16 that the management program manages.

The server HBA 312 is an identifier of a HBA on the side of the business server 16 having the business server name 310.

The storage HBA 314 is an identifier of a HBA on the storage apparatus 18 side.

The LDEV 316 is an identifier of the LDEV 42 provided to the business server 16 having the business server name 310.

A record for “server A” as the business server name 310 in the management DB 301A in FIG. 6 shows that it is possible for the business server 16 having the server name “server A” to access the LDEV 42 having the identifier “L01” (316) through a disk path that links the server HBA 312 having the identifier “ABCD01234” and the storage HBA 314 having the identifier “01234ABCD”.

A management DB 301B shows that a management DB of Ver. 2 has a column for an A-system pool device 318 in addition to the columns of the management DB 301A of Ver. 1.

A management DB 301C shows that in a management DB of Ver. 3, from the columns of the management DB 301B of Ver. 2, the column for the A-system pool device 318 is deleted.

Accordingly, in the case of updating the management program from Ver. 1 to Ver. 2, it is necessary to add a column for the A-system pool device 318 in the management DB 301A.

In the case of updating the management program from Ver. 2 to Ver. 3, it is necessary to delete the column for the A-system pool device from the management DB 301B.

In the case of updating the management program Ver. 1 to Ver. 3, it is not necessary to change the columns of the management DB 301A. This is because the columns which the management DB 301A of Ver. 1 has are the same as the columns which the management DB 301C of Ver. 3 has.

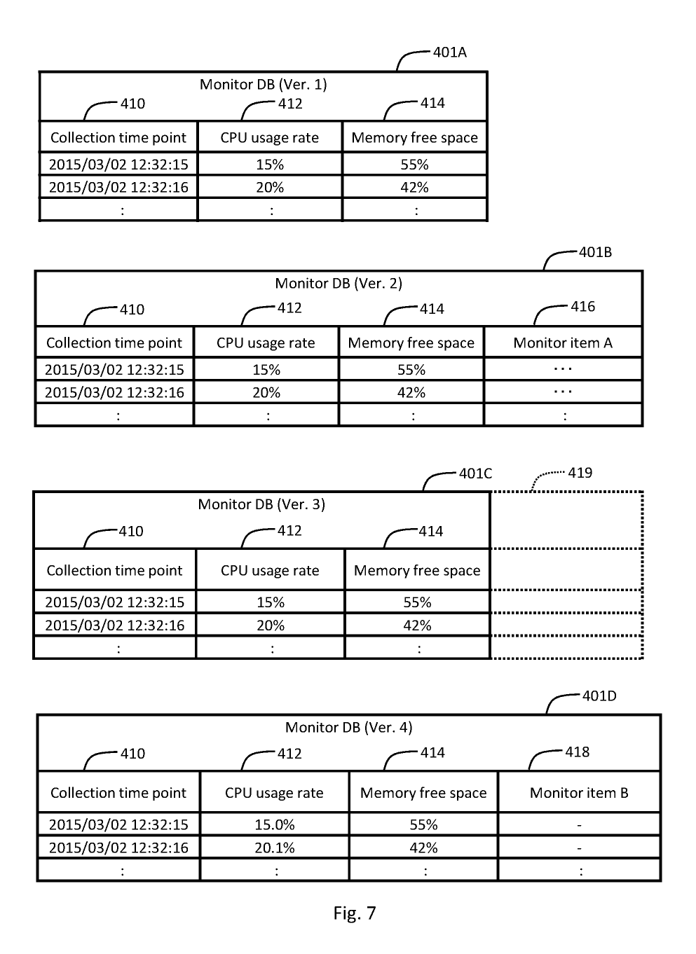

FIG. 7 illustrates a configuration example of a monitor DB 401 for respective versions. The monitor DB 401 is utilized from a monitor program.

In FIG. 7, a monitor DB 401A shows that, as columns, a monitor DB of Ver. 1 has a column for a collection time point 410, a CPU usage rate 412, and a memory free space 414.

The collection time point 410 is the time point at which the monitor program collected information regarding the CPU usage rate 412 and the memory free space 414 (that is, monitoring information).

The CPU usage rate 412 is the usage rate of the CPU at the collection time point 410 at the server which the monitor program is monitoring.

The memory free space 414 is the free space of the memory at the collection time point 410 at the server which the monitor program is monitoring.

A monitor DB 401B shows that, in addition to the columns which the management DB 401A of Ver. 1 has, a monitor DB of Ver. 2 has a column for a monitor item A 416.

A monitor DB 401C shows that in a monitor DB of Ver. 3, from the columns of the management DB 401B of Ver. 2, the column for the monitor item A 416 is deleted.

A monitor DB 401D shows that, in addition to the columns which the management DB 401C of Ver. 3 has, a monitor DB of Ver. 4 has a column for a monitor item B 418.

Accordingly, in the case of updating the monitor program from Ver. 1 to Ver. 2, it is necessary to add a column for the monitor item A 416 in the monitor DB 401A.

In the case of updating the monitor program from Ver. 2 to Ver. 3, it is necessary to delete the column for the monitor item A 416 from the monitor DB 401B.

In the case of updating the monitor program from Ver. 1 to Ver. 3, it is not necessary to change the columns of the monitor DB 401A. This is because the columns which the monitor DB 401A of Ver. 1 has are the same as the columns which the monitor DB 401C of Ver. 3 has.

In the case of updating the monitor program from Ver. 2 to Ver. 4, from the columns of the monitor DB 401B, it is necessary to delete the column for the monitor item A 416 and to add a column for the monitor item B 418.

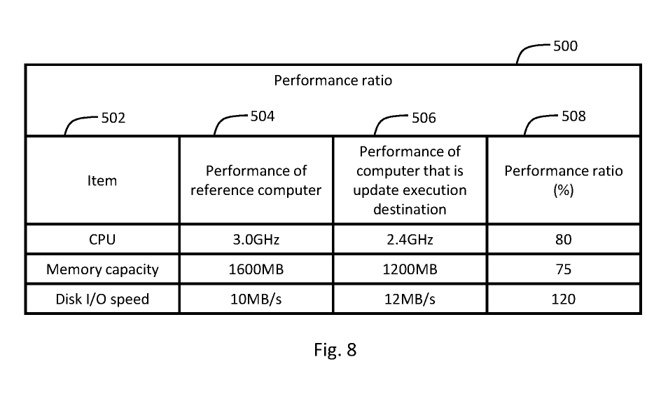

FIG. 8 illustrates an example of a method for calculating a performance ratio.

A performance ratio 508 is a value that shows a ratio between a performance 504 of a reference computer and a performance 506 of a computer that is the update execution destination. The performance ratio 508 may be calculated for each item 502 relating to a device of the computer.

In the example in FIG. 8, an operating frequency 504 of the CPU of the reference computer is “3.0 GHz”, and an operating frequency 506 of the CPU of the computer that is the update execution destination is “2.4 GHz”. In this case, the bulk installer 90 may calculate the performance ratio 508 of a CPU 502 as “2.4÷3.0×100=80%”.

Further, a capacity 504 of the memory of the reference computer is “1600 MB”, and a capacity 506 of the memory at the update execution destination is “1200 MB”. In this case, the bulk installer 90 may calculate the performance ratio 508 of a memory 502 as “1200÷1600×100=75%”.

Furthermore, a disk I/O speed 504 of the reference computer is “10 MB/s”, and a disk I/O speed 506 of the computer that is the update execution destination is “12 MB/s”. In this case, the bulk installer 90 may calculate the performance ratio 508 of the disk I/O speed 502 as “12÷10×100=120%”.

The performance 506 of the computer that is the update execution destination may be a value that is calculated based on actual measurement at the computer, or may be a value that is defined in advance for the computer.

The performance 504 of the reference computer may be a value that is defined in advance by the vendor of the bulk installer 90. The bulk installer 90 may include the performance 504 of the reference computer.

FIG. 9 illustrates an example of a method for calculating the estimated update time.

The bulk installer 90 may calculate the estimated update time 246 based on changes in the column configuration of the DB between before and after updating, the amount of information registered in the DB that is an update target, and the performance ratio of the computer that is the update execution target. An example of calculating the estimated update time 246 will now be described using FIG. 9.

In the case illustrated in FIG. 6, when updating the management program from Ver. 1 to Ver. 2, in accompaniment with the updating it is necessary to update the management DB 301A to the management DB 301B in which the column for the A-system pool device 318 is to be added. In this case, the update program performs the following processing with respect to the management DB 301A.

(S31) A column for the A-system pool device 318 is added to the management DB 301A (604). Addition of this column may be performed by means of a Structured Query Language (SQL) command (606).

(S32) An initial value is stored in the A-system pool device 318 column of each record. The initial value may be calculated based on a value registered in the management DB 301A.

In this case, with regard to the processing in S31, it is assumed that the time needed for a single processing operation by the CPU of the reference computer is “30 ms” (608), and the time needed for a single processing operation based on the disk I/O of the reference computer is “10 ms” (610). It is assumed that the performance ratio of the CPU at a calculation server as the update execution destination is “80%” (608), and the performance ratio of the disk I/O speed is “120%” (610). Since the number of executions in S31 is “once” (612), the bulk installer 90 calculates the processing time in S31 as “(30×1×0.8)+(10×1×1.2)=36 ms” (614).

Further, with respect to the processing in S32, it is assumed that the time taken for a single processing operation based on the CPU of the reference computer is “5 ms” (608), and the time taken for a single processing operation based on the disk I/O of the reference computer is “10 ms” (610). The number of executions of S32 will be the number of records in the management DB 301B. For example, if it is assumed that the number of business servers registered in the management DB 301A is “100”, and the number of LDEVs registered in the management DB 301A is “100000”, the number of records in the management DB 301B will be “10000×100=1000000”. That is, the number of executions of S32 is “1000000 times” (612). Accordingly, the bulk installer 90 calculates the processing time for S32 as “(5×1000000×0.8)+(10×1000000×1.2)=83 min” (614).

In this case, taking into consideration the update time of the management DB, the bulk installer 90 may calculate the estimated update time for updating the management program from Ver. 1 to Ver. 2 as “36 ms+83 min”.

Further, when updating the management program from Ver. 2 to Ver. 3 as illustrated in FIG. 6, in accompaniment therewith it is necessary to update the management DB 301B to the management DB 301C from which the column for the A-system pool device 318 is deleted. In this case, the update program performs the following processing with respect to the management DB 301B.

(S33) The update program deletes the column for the A-system pool device 318 from the management DB 301B.

In this case, with respect to the processing in S33, it is assumed that the time taken for a single processing operation by the CPU of the reference computer is “30 ms” (608), and the time taken for a single processing operation based on the disk I/O of the reference computer is “10 ms” (610). The performance ratio of the CPU and the performance ratio of the disk I/O speed are assumed to be the same as described above. Since the number of executions of S33 is “once” (612), the bulk installer 90 calculates the processing time for S33 as “(30×1×0.8)+(10×1×1.2)=36 ms”.

In this case, the bulk installer 90 may calculate the estimated update time for updating the management program from Ver. 2 to Ver. 3 as “36 ms”.

Next, a case in which the management program is updated from Ver. 1 to Ver. 3 will be considered. When updating from Ver. 1 to Ver. 2, the update program for updating to Ver. 2 adds a column for the A-system pool device 318 to the management DB 301A. However, when updating from Ver. 2 to Ver. 3, the update program for updating to Ver. 3 deletes the column for the A-system pool device 318 from the management DB 301B. That is, when updating the management program from Ver. 1 to Ver. 3, it is not necessary for the update program for updating to Ver. 3 to change the column configuration of the management DB 301A.

In this case, the bulk installer 90 may calculate the estimated update time for updating the management program from Ver. 1 to Ver. 3 as “0”.

A method for calculating an estimated update time with respect to the monitor program is the same as the above described calculation method.

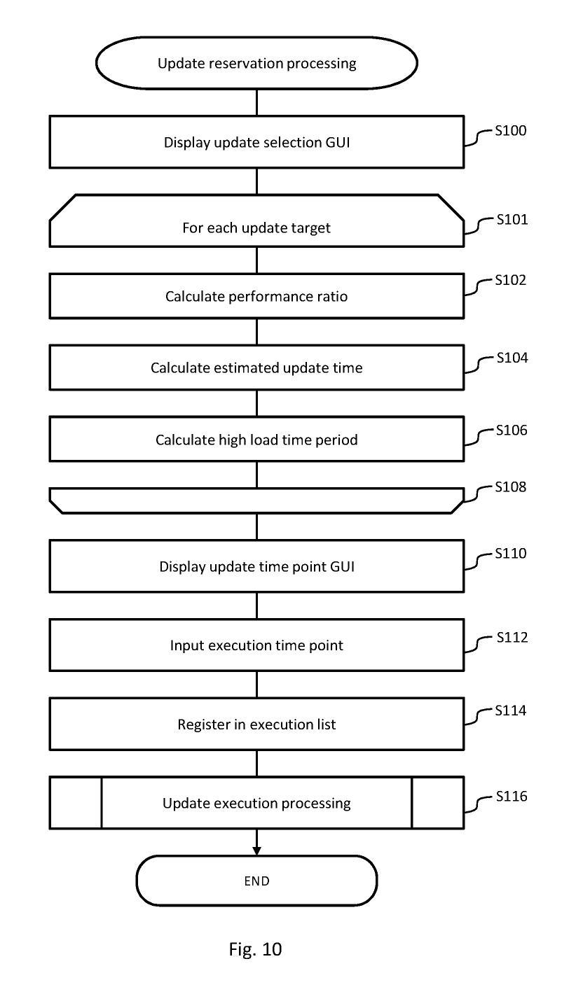

FIG. 10 illustrates an example of a flowchart of update reservation processing.

Upon being executed, for example, the bulk installer 90 displays the update selection GUI 200 as illustrated in FIG. 2 (S100). The user selects update programs to be taken as execution targets through the GUI 200.

For each update program selected in S100, the bulk installer 90 performs loop processing of the following S101 to S108 (S101). In the following description of the loop processing of S101 to S108, an update program that is the processing target is referred to as “target update program”.

The bulk installer 90 calculates the performance ratio of the computer at which the target update program is to be executed, for example, in the manner described above referring to FIG. 8 (S102).

The bulk installer 90 calculates the estimated update time at the computer at which the target update program is to be executed, for example, in the manner described above referring to FIG. 9 (S104).

The bulk installer 90 calculates a high load time period at the computer at which the target update program is to be executed (S106).

Note that, in a case where calculation of the performance ratio (S102) and calculation of a high load time period (S106) were already performed in processing prior to S102 and S106, the calculations in S102 and S106 may be omitted.

After the end of the loop processing of S101 to S108, the bulk installer 90, for example, displays the update time point GUI 240 illustrated in FIG. 3 (S110). The estimated update times 246 and the high load time periods 248 included in the GUI 240 are calculated by the aforementioned loop processing.

The user may input or change the scheduled start time point 252 of each update program included in the GUI 240 (S112). A case where the scheduled start time point 252 is not input may mean that the update program is to be executed immediately.

The bulk installer 90 registers each update program in an execution list in the order of the earliest to latest scheduled start time points 252 (S114). In this case, an update program to be immediately executed may be registered at the beginning of the execution list.

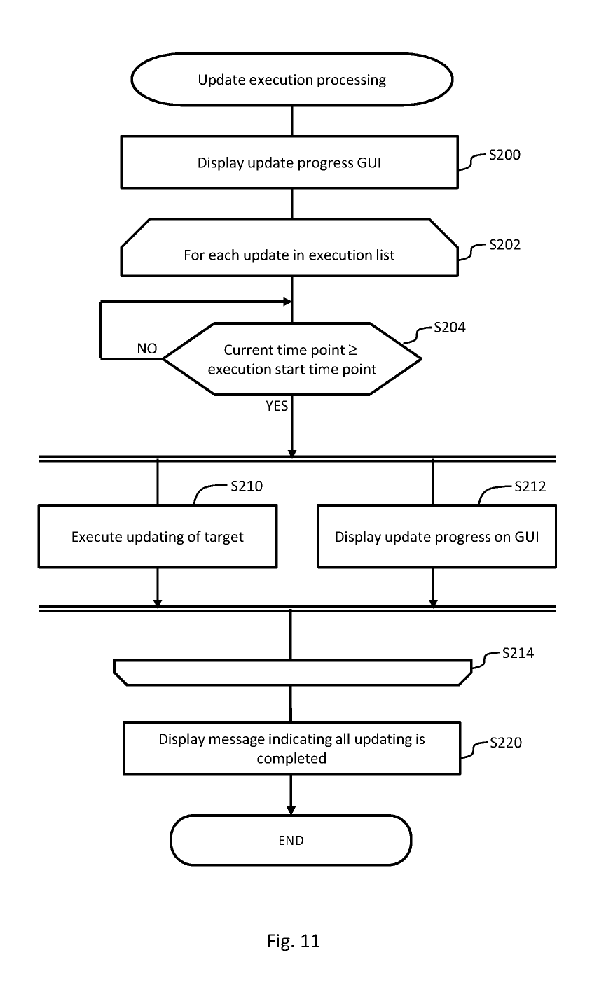

The bulk installer 90 performs update execution processing (S116). This processing is described in detail later (see FIG. 11).

The bulk installer 90 then ends the present processing (END). Thus, update programs included in the bulk installer 90 are executed at a management server or a monitor server, and programs and DBs that are update targets are updated.

According to the above described processing, by means of the update time point GUI 240 the user can know a more accurate estimated update time 246 for each update program, and also know high load time periods 248 at servers at which the update programs are to be executed. Thereby the user can decide an appropriate scheduled start time point 252 for each update program. In addition, by displaying the recommended start time point 250 on the update time point GUI 240, the user can more easily decide an appropriate scheduled start time point 252 for each update program.

FIG. 11 illustrates an example of a flowchart of update execution processing. The present processing is a detailed description of the processing in S116 in FIG. 10.

The bulk installer 90 displays the update progress GUI 260 as illustrated, for example, in FIG. 5 (S200).

The bulk installer 90 selects the first update program among unexecuted update programs registered in the execution list, and performs loop processing of S202 to S214 described hereunder (S202). In the following description of the loop processing of S202 to S214, an update program taken as the processing target is referred to as “target update program”.

The bulk installer 90 determines whether or not the current time point is past the scheduled start time point of the target update program (S204).

If the current time point is not past the scheduled start time point of the target update program (S204: NO), the bulk installer 90 waits until the scheduled start time point of the target update program.

If the current time point is past the scheduled start time point of the target update program (S204: YES), the bulk installer 90 proceeds to the processing in the subsequent S210 and S212. Note that, in a case where the predetermined start time point of the target update program is “immediate execution”, the bulk installer 90 always determines “YES” as the result of the determination in S204.

The bulk installer 90 causes the update program to be executed at the server that is the execution target (S210).

In accompaniment therewith, the bulk installer 90 acquires information showing the progress status of the update program that is being executed, and reflects the progress status in the update progress GUI 260 (S212).

After execution of the update program is completed, the bulk installer 90 determines whether or not an unexecuted update program remains in the execution list (S214), and if an unexecuted update program remains, the bulk installer 90 returns to S202. If there is no remaining unexecuted update program, the bulk installer 90 displays a message to the effect that all updating is completed on the GUI 260 (S220), and ends the present processing (END).

According to the above described processing, by means of the update progress GUI 260, the user can know at one time the progress of the overall updating and the progress of respective updates. Further, the user can know at one time the scheduled end time point of the overall updating and the scheduled end time point of respective updates.

The above described embodiment is an example for describing the present invention, and it is not intended to limit the scope of the present invention to only this embodiment. A person skilled in the art can implement the present invention in a variety of other modes without departing from the gist of the present invention.

### REFERENCE SIGNS LIST

1: Storage system, 10: Management client, 12: Management server, 14: Monitor server, 16: Business server, 18: Storage apparatus

1. A management system configured to manage a storage system, comprising:
a storage device configured to hold an information processing program configured to manage information pertaining to a storage system by utilizing a database; and
a processor configured to execute an update program configured to update the information processing program and the database utilized by the information processing program;
wherein the update program is configured to:
calculate an estimated update time that is an estimated time that will be needed to update the information processing program and the database based on a size of at least one portion of the database utilized by the information processing program before being updated and a structure of the database utilized by the information processing program after being updated, and
output the estimated update time that is calculated.

2. The management system according to claim 1, wherein
a reference update time that is a time taken in a case where the update program is executed by a processor having a predetermined processing performance and a database having a predetermined I/O performance is updated is used to calculate the estimated update time

3. The management system according to claim 2, wherein the update program includes the reference update time.

4. The management system according to claim 3, wherein the reference update time is calculated by a vendor of the storage system before distributing the update program.

5. The management system according to claim 2, wherein
to calculate the estimated update time, a value is used that is obtained by converting the reference update time based on a processing performance of a processor at which the update program is to be executed and an I/O performance of a database to be updated by the update program.

6. The management system according to claim 2, wherein processing by which the update program updates the database includes
processing that adds a new item to the database before being updated;
processing that calculates an initial value relating to a new item using at least one portion of information of the database before being updated; and
processing that stores the initial value that is calculated in a new item of at least some records.

7. The management system according to claim 2, wherein the update program is configured to
calculate a high load time period in which, during a single day, there is a tendency for a processing load of the storage system to be equal to or larger than a threshold value based on tendencies of past processing loads of the storage system;
calculate a scheduled end time point of the update program based on a scheduled start time point of the update program and the estimated update time; and
in a case where a time period from the scheduled start time point to the scheduled end time point overlaps with at least one part of the high load time period, display such information.

8. The management system according to claim 7, wherein the update program is configured to
calculate a time point at which the estimated update time does not overlap with any of the high load time periods, and display the calculated time point as a scheduled start time point that is recommended.

9. The management system according to claim 7, wherein the update program is configured to
display the scheduled start time point that is recommended, the estimated update time and the high load time period; and
accept input of the scheduled start time point.

10. The management system according to claim 7, wherein
when an update management program configured to manage execution of a plurality of update programs is executed by the processor, the update management program is configured to display a progress status and the scheduled end time point of each of the plurality of update programs, and a progress status and a scheduled end time point of all of the plurality of update programs.

11. A management method that is a method for managing a storage system,
a storage device configured to hold an information processing program that controls information pertaining to a storage system by utilizing a database,
the management method comprising:
a processor, by executing an update program that updates the information processing program and the database utilized by the information processing program,
calculates an estimated update time that is an estimated time that will be needed to update the information processing program and the database based on a size of at least one portion of the database utilized by the information processing program before being updated and a structure of the database utilized by the information processing program after being updated, and
outputs the estimated update time that is calculated.
